(19) United States
(12) Patent Application Publication
(10) Pub. No.: US 2007/0299179 A1
(43) Pub. Date: Dec. 27, 2007

(54) Moulded thermoplastic resin articles with travertine-like appearance

(75) Inventor: Foo Keong Tham, Kajang (MY)

Correspondence Address: BIRCH STEWART KOLASCH & BIRCH, PO BOX 747, FALLS CHURCH, VA, 22040-0747, US

(73) Assignee: Greenyield Industries (M) Sdn. Bhd., Kajang (MY)

(21) Appl. No.: 11/806,490

(22) Filed: May 31, 2007

(30) Foreign Application Priority Data
Jun. 1, 2006 (MY) 2006 2521

(51) Int. Cl. C08L 25/02; B29C 45/00; C08K 3/10; C08K 5/11

(52) U.S. Cl. 524/300; 264/328.1; 524/427; 524/577

(57) ABSTRACT

The present invention relates to moulded thermoplastic resin articles with travertine-like appearance which exhibit shrinkage of not more than 0.5% upon cooling after moulding process and have a density of at least 1.5 g/cm³. The articles comprise 30-60% by weight of styrene-based resin and 40-50% by weight of stone powder. The styrene-based resin used is selected from the group comprising polystyrene (PS), high impact polystyrene (HIPS), styrene-acrylonitrile copolymer (SAN), acrylonitrile-butadiene-styrene terpolymer (ABS) and blends of two or more thereof. The stone powder used has an average size range of 600-2000 mesh and it preferably comprises limestone powder or calcium carbonate. The articles may further comprise 1-3% by weight of impact modifier and/or up to 2% by weight of lubricant. The articles also may further comprise 1-3% by weight of colour pigments or dyes.

### FIELD OF THE INVENTION

The present invention relates to moulded thermoplastic resin articles with travertine-like appearance.

### BACKGROUND OF THE INVENTION

Articles with travertine-like appearance can be produced by (I) imprinting travertine-like design on plain moulded resin articles; or (II) blending additive for imparting travertine-like appearance with resin and moulding the resultant blend to form moulded resin articles with travertine-like appearance.

Method (I) is costly as it involves two processes: a primary process for forming the plain moulded resin articles and a secondary process for imprinting travertine-like design on the plain moulded resin articles. The articles produced according to this method are often associated with problems such as exposure of inner plain surface due to scratches and lost of travertine-like appearance due to colour fading or wear and tear.

Method (II) involves moulding a resin composition comprising a thermosetting and/or thermoplastic resin and an additive for imparting travertine-like appearance on the resultant moulded resin articles. When the resin composition used is thermosetting in nature, the articles are formed at a low productivity as high speed extrusion moulding and injection moulding methods are unsuitable for moulding such resin composition and the articles are not recyclable and not re-workable once formed. Hence, resin compositions of thermoplastic nature are preferably used for producing articles with travertine-like appearance.

U.S. Pat. No. 4,280,950 discloses a moulding having a grain resembling a natural material such as wood, stone and the like comprising a mixture of 0.1-20% by weight of coloured modified polyphenyleneoxide resin and 80-99.9% by weight of thermoplastic resin, said thermoplastic resin having a higher fluidity in the range of moulding temperature than said polyphenyleneoxide resin and selected from the group consisting of styrene resin, polyolefin resin, polyvinylchloride resin and polymethylmethacrylate resin.

U.S. Pat. No. 5,187,202 discloses an additive concentrate for imparting a simulated stone effect to thermoplastic substrates comprising a cellulosic short fibre or flock having a length of about 10 to about 125 milli-inches and fineness of about 1 to about 25 denier; and at least one dispersant aid selected from silicone fluids, glycerol plasticizers, epoxy plasticizers, metallic salts of fatty acids, waxes and mixtures thereof.

The moulding of U.S. Pat. No. 4,280,950 or articles made by using the additive concentrate of U.S. Pat. No. 5,187,202 as mentioned above may have travertine-like appearance but they are lacking in the sense of giving the feel of a genuine stone or earthen ware resulting from their low density.

### SUMMARY OF THE INVENTION

The present invention relates to articles with travertine-like appearance comprising 30-60% by weight of styrene-based resin and 40-50% by weight of stone powder.

The styrene-based resin used is selected from the group comprising polystyrene (PS), high impact polystyrene (HIPS), styrene-acrylonitrile copolymer (SAN), acrylonitrile-butadiene-styrene terpolymer (ABS) and blends of two or more thereof.

The stone powder used has an average size range of 600-2000 mesh and it preferably comprises limestone powder or calcium carbonate.

The articles may further comprise 1-3% by weight of impact modifier and/or up to 2% by weight of lubricant.

The impact modifier used is a thermoplastic elastomer, preferably a styrene-based thermoplastic elastomer and particularly selected from the group comprising styrene-butadiene-styrene block copolymer (SBS), styrene-ethylene-butadiene-styrene (SEBS) and blends thereof.

The lubricant used is preferably a plant-based lubricant, particularly a vegetable oil or a blend of vegetable oils and more particularly palm oil.

The articles also may further comprise 1-3% by weight of colour pigments or dyes.

The articles are produce-able by injection moulding. They exhibit shrinkage of not more than 0.5% upon cooling after moulding process and have a density of at least 1.5 g/cm³.

### DETAILED DESCRIPTION OF THE INVENTION

The present invention relates to articles with travertine-like appearance made from a resin composition comprising 30-60% by weight of styrene-based resin and 40-50% by weight of stone powder; optionally including 1-3% by weight of impact modifier and/or up to 2% by weight of lubricant.

The term travertine-like appearance is referring to appearance of decorative stones such as granite, marble, travertine and the like.

The styrene-based resin is of thermoplastic nature including polystyrene (PS), high impact polystyrene (HIPS), styrene-acrylonitrile copolymer (SAN), acrylonitrile-butadiene-styrene terpolymer (ABS) and blends of two or more thereof, with high impact polystyrene (HIPS) being the preferred type of styrene-based resin.

The stone powder generally has an average size range of 600-2000 mesh including those from igneous, sedimentary or metamorphic rocks, with limestone powder or calcium carbonate (CaCO₃) being the preferred type of stone powder.

The impact modifier is generally a thermoplastic elastomer (TPE), preferably a styrene-based thermoplastic elastomer including styrene-butadiene-styrene block copolymer (SBS), styrene-ethylene-butadiene-styrene (SEBS) and blends thereof.

The lubricant is preferably a plant-based lubricant including vegetable oils, more preferably palm oil.

The resin composition may further includes 1-3% by weight of colour pigments or dyes and, if necessary, other common additives such as mould release agents, antioxidants, UV absorbers, fungicides, flame retardants and the like in minor quantities.

The resin composition can be prepared by using any method capable of uniformly mixing the mentioned components together. For example, the resin composition can be prepared by (a) preliminary mixing together the mentioned components at their given proportion by using a mixer, follow by (b) melt kneading the resultant mixture from (a) by using an extruder and the resin composition thus prepared can be processed into pellet or other forms and stored for future use.

For producing articles with travertine-like appearance, the resin composition can be moulded into the shape and dimension of the desired articles by employing any method generally use for moulding thermoplastic resin and compositions thereof, preferably by injection moulding. The articles can be utilitarian, such as flower pot or its equivalent including plant pot and planter, and/or decorative.

The articles produced have good dimensional stability and exhibit shrinkage of not more than 0.5% upon cooling after moulding process. They offer not only travertine-like appearance but also the feel of a genuine stone or earthen ware resulting from their high density of at least 1.5 g/cm³.

The present invention will now be illustrated by the following examples in a non-limiting sense.

### EXAMPLE 1

### Preparing the Resin Composition for Producing Articles With Travertine-Like Appearance

A resin composition for producing articles with travertine-like appearance was prepared by using
i) 49% by weight of high impact polystyrene (HIPS);
ii) 46% by weight of limestone powder having an average size of about 1000 mesh;
iii) 2% by weight of styrene-based thermoplastic elastomer;
iv) 1% by weight of palm oil; and
v) 2% by weight of colour pigments.

The resin composition as mentioned above was prepared according to the following steps:
a) preliminary mixing together various components of the resin composition at their given proportion by using a mixer;
b) feeding the resultant mixture from (a) to an extruder for melt kneading at a temperature of about 180-240° C.;
c) extruding the melt kneaded resin composition in a strand form with diameter of about 3 mm into water for cooling;
d) cutting the strand form resin composition into pellets having a size of up to 5 mm by using an automatic cutter.

### EXAMPLE 2

### Producing Articles With Travertine-Like Appearance

Pellets of the resin composition as obtained in Example 1 were used in producing flower pots according to the following steps:
a) feeding pellets of the resin composition as mentioned above to an injection moulding machine for heating to a temperature of about 180-240° C.;
b) injecting the molten resin composition into a mould of flower pot shape by using a pressure of about 180 tonnes;
c) releasing the moulded flower pot from its mould and cooling the moulded flower pot.

The moulded flower pots have a travertine-like appearance and give the feel of a genuine stone or earthen ware. They exhibited shrinkage of not more than 0.5% upon cooling after moulding process and they have a density of at least 1.5 g/cm³.

1) An article with travertine-like appearance comprising 30-60% by weight of styrene-based resin and 40-50% by weight of stone powder.

2) An article according to claim 1 wherein the styrene-based resin is selected from the group comprising polystyrene (PS), high impact polystyrene (HIPS), styrene-acrylonitrile copolymer (SAN), acrylonitrile-butadiene-styrene terpolymer (ABS) and blends of two or more thereof.

3) An article according to claim 1 wherein the stone powder has an average size range of 600-2000 mesh.

4) An article according to claim 1 wherein the stone powder comprises limestone powder or calcium carbonate.

5) An article according to claim 1 further comprising 1-3% by weight of impact modifier.

6) An article according to claim 1 or 5 further comprising up to 2% by weight of lubricant.

7) An article according to claim 5 wherein the impact modifier is a thermoplastic elastomer.

8) An article according to claim 7 wherein the impact modifier is a styrene-based thermoplastic elastomer.

9) An article according to claim 8 wherein the impact modifier is selected from the group comprising styrene-butadiene-styrene block copolymer (SBS), styrene-ethylene-butadiene-styrene (SEBS) and blends thereof.

10) An article according to claim 6 wherein the lubricant is a plant-based lubricant.

11) An article according to claim 10 wherein the lubricant is a vegetable oil or a blend of vegetable oils.

12) An article according to claim 11 wherein the lubricant is palm oil.

13) An article according to claim 1 further comprising 1-3% by weight of colour pigments or dyes.

14) An article according to claim 1 exhibiting shrinkage of not more than 0.5% upon cooling after moulding process.

15) An article according to claim 1 having density of at least 1.5 g/cm³.

16) An article according to claim 1 produce-able by injection moulding.
